(19) United States
(12) Patent Application Publication
(10) Pub. No.: US 2005/0158040 A1
(43) Pub. Date: Jul. 21, 2005

(54) Optical disk reproducing apparatus

(76) Inventor: Akihiro Yuba, Osaka (JP)

Correspondence Address: LORUSSO, LOUD & KELLY, 3137 Mount Vernon Avenue, Alexandria, VA, 22305, US

(21) Appl. No.: 11/033,150

(22) Filed: Jan. 12, 2005

(30) Foreign Application Priority Data
Jan. 19, 2004 (JP) 2004-010550

(51) Int. Cl. H04N 5/781

(52) U.S. Cl. 386/126

(57) ABSTRACT

The present invention provides an optical disk reproducing apparatus adapted to prevent users to perform an extraneous erroneous operation when requesting to restart the reproduction successively after displaying a menu screen, and to facilitate a return when the menu key has been pressed erroneously during, for example, the reproduction of a main part. When the menu key is pressed, a message “Press the menu key to restart the reproduction successively” indicating resume reproduction is displayed on the menu screen 31, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and therefore improves the operationality of the optical disk reproducing apparatus.

### BACKGROUND OF THE INVENTION

1. Field of the Invention

The present invention relates to an optical disk reproducing apparatus for reproducing information recorded on optical disk, and particularly to processing associated with menu key operation.

2. Description of the Prior Art

In recent years, DVD (Digital Versatile Disk) has been becoming popular as optical disk. In such DVDs are stored various kinds of data in an intermingled manner by employing image data compression techniques and/or audio data compression techniques such as MPEG-2, as well as control data (navigation pack information, etc.) used for achieving various functions.

In the case of recording, for example, a movie on a DVD, video data and audio data are generally recorded, while recording additional subtitle data in multiple languages allows subtitles in a language selected by a user to be displayed. Also, recording still image data such as movie director's and/or performer's profiles allows them to be displayed by a user operation. Further, in optical disk reproducing apparatuses is provided a so-called resuming function, which operates in such a manner that in the case of temporarily stopping the reproducing operation for a DVD and then restarting the operation, it restarts from the stop position. Thus, optical disk reproducing apparatuses read various kinds of data out of DVDs and operate in order to achieve their various functions.

In such optical disk reproducing apparatuses as above, there is a menu function as one of various functions, which includes, for example, a function for displaying an operation button selected by a user on a menu screen and a button color change function (highlight function) for indicating that the operation button is selected. In respect to menu, there are provided title menu, root menu, audio menu, subpicture menu, angle menu, chapter menu, and other various menus.

In the meanwhile, pressing the menu key on the remote controller or the operation section of the main body, which is required for displaying a menu screen on the display device, during the reproduction of a main part stops the reproduction and stores resume information at the point in a memory. Then, pressing the menu key again allows so-called resume reproduction, which restarts the reproduction successively from the stop position based on the resume information stored in the memory.

Although it has thus been the case in optical disk reproducing apparatuses that pressing the menu key during the reproduction of a main part transits to a menu screen, the resuming function which operates in such a manner that pressing the menu key again after the transition allows a return to the position where the main part has been reproduced partially is not well known by users. Accordingly, there is to occur a problem that when requesting to restart the reproduction successively after displaying a menu screen, users may perform an extraneous erroneous operation to fail to perform resume reproduction, or that when the menu key has been pressed during, for example, the reproduction of a main part, if users do not know that they have only to press the menu key again, any difficult return operation will be required.

In the prior art described in Japanese Patent Laid-Open Publication No. 2000-311420, although it is arranged that a stop position menu screen including stop position related information is displayed based on stop position specifying data, and that if any one of the displayed stop position related information is selected, the reproducing operation of image and voice will be started from the corresponding stop position based on the stop position specifying data, there is no disclosure about resume reproduction when pressing the menu key again, and therefore it is impossible to solve the above-mentioned problems.

In the prior art described in Japanese Patent Laid-Open Publication No. 2001-312880, wherein route menu and title menu, which can easily be confused by users, are arranged to be displayed in one screen, there is also no disclosure about resume reproduction when pressing the menu key again, and therefore it is impossible to solve the above-mentioned problems.

### SUMMARY OF THE INVENTION

The present invention has been made to solve the above-mentioned problems, and an object thereof is to provide an optical disk reproducing apparatus adapted to prevent users to perform an extraneous erroneous operation when requesting to restart the reproduction successively after displaying a menu screen, and to facilitate a return when the menu key has been pressed erroneously during, for example, the reproduction of a main part.

In order to achieve the above-mentioned object, the invention according to claim 1 provides an optical disk reproducing apparatus for reproducing information recorded on optical disk, the apparatus comprising a system controller including: a resume reproduction availability determining means for obtaining and analyzing navigation pack information contained in disk information before starting the reproduction of main part information for an optical disk, and for determining whether or not the optical disk can support resume reproduction; a resume reproduction availability information storage processing means for storing, in the case the resume reproduction is determined to be available, resume reproduction availability information indicating the availability of the resume reproduction in a memory means; a menu screen display processing means for displaying a menu screen on a display means when a menu key is pressed during the reproduction of the main part; a resume information existence determining means for determining whether or not there exists resume information stored in the memory means when the menu key is pressed; a message display processing means for displaying a message indicating that pressing the menu key allows resume reproduction on the menu screen in the case resume reproduction availability information is stored in the memory means and the optical disk can support resume reproduction, and when it is determined that there exists resume information by the resume information existence determining means; a resume reproduction unavailability processing means for indicating that the optical disk cannot support resume reproduction and performing predetermined processing in the case no resume reproduction availability information is stored in the memory means and the optical disk cannot support resume reproduction, and when it is determined that there exists no resume information by the resume information existence determining means; and a resume reproduction means for performing resume reproduction when the menu key is pressed after the message is displayed on the menu screen by the message display processing means.

In the above arrangement, when the reproduction for the optical disk is started, the navigation pack information contained in the disk information is obtained and analyzed, and it is determined whether or not the optical disk can support resume reproduction by the resume reproduction availability determining means. In the case the resume reproduction is determined to be available, the resume reproduction availability information indicating the availability of the resume reproduction is stored in the memory means by the resume reproduction availability information storage processing means.

Then, when the menu key is pressed during the reproduction of the main part, the menu screen is displayed on the display means by the menu screen display processing means, and when the menu key is pressed, it is determined whether or not there exists resume information stored in the memory means by the resume information existence determining means. In the case resume reproduction availability information is stored in the memory means and the optical disk can support resume reproduction, and when it is determined that there exists resume information by the resume information existence determining means, the message indicating that pressing the menu key allows resume reproduction is displayed on the menu screen by the message display processing means.

In the case no resume reproduction availability information is stored in the memory means and the optical disk cannot support resume reproduction, and when it is determined that there exists no resume information by the resume information existence determining means, it is indicated that the optical disk cannot support resume reproduction and predetermined processing is performed by the resume reproduction unavailability processing means. If the optical disk cannot support resume reproduction, displaying, for example, an inhibition mark indicating the unavailability of resume reproduction on the menu screen allows users to know that the optical disk cannot support resume reproduction. When the menu key is pressed after the message is displayed on the menu screen by the message display processing means, resume reproduction is performed by the resume reproduction means.

In accordance with the above arrangement, when the menu key is pressed, the message indicating that pressing the menu key again allows resume reproduction is displayed on the menu screen, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and further if the optical disk cannot support resume reproduction, displaying, for example, an inhibition mark indicating the unavailability of resume reproduction on the menu screen allows users to know that the optical disk cannot support resume reproduction. Therefore, the optical disk reproducing apparatus with this arrangement is easily operable for users and the operationality thereof is improved.

The invention according to claim 2 provides an optical disk reproducing apparatus for reproducing information recorded on optical disk, the apparatus comprising a system controller adapted to control in such a manner that when a menu key is pressed during the reproduction of a main part in an optical disk capable of supporting resume reproduction, a message indicating that pressing the menu key allows resume reproduction is displayed on a menu screen.

In the above arrangement, when the menu key is pressed during the reproduction of the main part in the optical disk capable of supporting resume reproduction, the message indicating that pressing the menu key allows resume reproduction is displayed on a menu screen.

In accordance with the above arrangement, when the menu key is pressed, the message indicating that pressing the menu key again allows resume reproduction is displayed on the menu screen, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and therefore the optical disk reproducing apparatus with this arrangement is easily operable for users and the operationality thereof is improved.

In the invention according to claim 3, the determination in the invention according to claim 2 whether or not the optical disk can support resume reproduction is made based on navigation pack information contained in disk information, whereby it is determined whether or not the optical disk can support resume reproduction.

In the invention according to claim 4, the system controller of the invention according to claim 2 comprises: a resume reproduction availability determining means for obtaining and analyzing navigation pack information contained in disk information before starting the reproduction of main part information for the optical disk, and for determining whether or not the optical disk can support resume reproduction; a resume reproduction availability information storage processing means for storing, in the case the resume reproduction is determined to be available, resume reproduction availability information indicating the availability of the resume reproduction in a memory means; a menu screen display processing means for displaying the menu screen on a display means when the menu key is pressed during the reproduction of the main part; a resume information existence determining means for determining whether or not there exists resume information stored in the memory means when the menu key is pressed; a message display processing means for displaying a message indicating that pressing the menu key allows resume reproduction on the menu screen in the case resume reproduction availability information is stored in the memory means and the optical disk can support resume reproduction, and when it is determined that there exists resume information by the resume information existence determining means; and a resume reproduction means for performing resume reproduction when the menu key is pressed after the message is displayed on the menu screen by the message display processing means, whereby when the menu key is pressed to display the menu screen, the message indicating that pressing the menu key again allows resume reproduction is displayed on the menu screen.

In the invention according to claim 5, the system controller of the invention according to claim 4 comprises a resume reproduction unavailability processing means for indicating that the optical disk cannot support resume reproduction and performing predetermined processing in the case no resume reproduction availability information is stored in the memory means and the optical disk cannot support resume reproduction, and when it is determined that there exists no resume information by the resume information existence determining means, whereby if the optical disk cannot support resume reproduction, displaying, for example, an inhibition mark indicating the unavailability of resume reproduction on the menu screen allows users to know that the optical disk cannot support resume reproduction.

As described heretofore, in accordance with the present invention, since the system controller including the resume reproduction availability determining means, the resume reproduction availability information storage processing means, the menu screen display processing means, the resume information existence determining means, the message display processing means, the resume reproduction unavailability processing means, and the resume reproduction means is provided, when the menu key is pressed, the message indicating that pressing the menu key again allows resume reproduction is displayed on the menu screen, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and further if the optical disk cannot support resume reproduction, displaying, for example, an inhibition mark indicating the unavailability of resume reproduction on the menu screen allows users to know that the optical disk cannot support resume reproduction. Therefore, the optical disk reproducing apparatus with this arrangement is easily operable for users and the operationality thereof is improved.

Additionally in accordance with the present invention, since the system controller, which is adapted to control in such a manner that when the menu key is pressed during the reproduction of a main part in an optical disk capable of supporting resume reproduction, the message indicating that pressing the menu key allows resume reproduction is displayed on the menu screen, is provided, when the menu key is pressed, the message indicating that pressing the menu key again allows resume reproduction is displayed on the menu screen, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and therefore the optical disk reproducing apparatus with this arrangement is easily operable for users and the operationality thereof is improved.

### BRIEF DESCRIPTION OF THE DRAWINGS

FIG. 1 is a block diagram showing the configuration of an optical disk reproducing apparatus according to an embodiment of the present invention;

FIG. 2 is a view showing the data structure of a VOB (Video Object) containing video data, i.e., reproduction data used for reproducing a menu screen for selecting a title in the embodiment;

FIG. 3 is a view showing an example of the menu screen in the embodiment; and

FIG. 4 is a flow chart illustrating processing associated with menu key operation in the embodiment.

### DESCRIPTION OF THE PREFERRED EMBODIMENTS

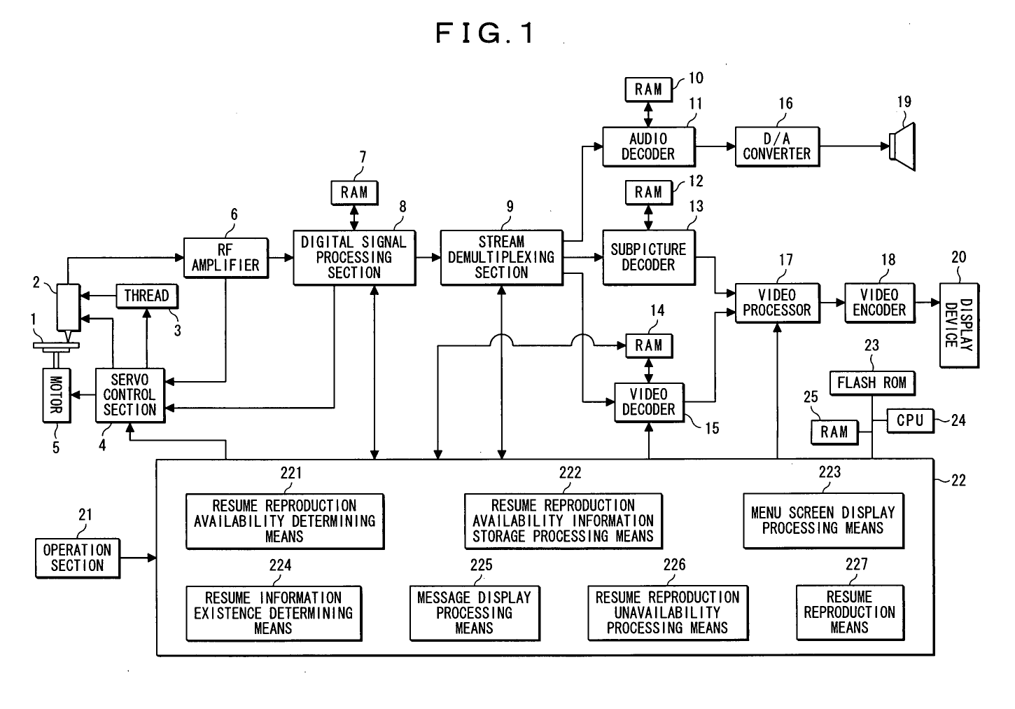

An embodiment of the present invention will hereinafter be described with reference to the accompanying drawings. FIG. 1 is a block diagram showing the configuration of an optical disk reproducing apparatus according to the embodiment of the present invention.

The optical disk reproducing apparatus comprises a spindle motor 5 for rotating an optical disk 1, an optical pickup 2 for emitting laser beam to reproduce information recorded on the optical disk 1 and for receiving reflected light from the optical disk 1, a thread 3 for moving the optical pickup 2 in the radius direction of the optical disk 1, and a servo control section 4 for driving the spindle motor 5 and the thread 3 and for controlling in such a manner as to move the focal position of laser beam perpendicular and parallel to the recording surface of the optical disk 1 by moving an objective lens (not shown in the figure) built in the optical pickup 2 in accordance with an instruction from a system controller 22.

The optical disk reproducing apparatus also comprises an RF amplifier 6 for amplifying RF signal, i.e., read-out signal from the optical pickup 2 when reproducing the optical disk 1, a digital signal processing section 8 for performing signal demodulation processing and error correction processing in accordance with the data format of the optical disk 1 after converting an RF signal output from the RF amplifier 6 into digital data and then storing generated data in a RAM 7, and a stream demultiplexing section 9 for demultiplexing data stream output from the digital signal processing section 8 into audio data, subpicture data and video data in accordance with an instruction from the system controller 22.

The optical disk reproducing apparatus further comprises an audio decoder 11 for performing predetermined decode processing by inputting audio data output from the stream demultiplexing section 9, a RAM 10 for storing data temporarily to perform decode processing in the audio decoder 11, a subpicture decoder 13 for performing predetermined decode processing by inputting subpicture data output from the stream demultiplexing section 9, a RAM 12 for storing data temporarily to perform decode processing in the subpicture decoder 13, a video decoder 15 for performing predetermined decode processing by inputting video data output from the stream demultiplexing section 9, and a RAM 14 for storing data temporarily to perform decode processing in the video decoder 15.

The optical disk reproducing apparatus still further comprises a video processor 17 for synthesizing data output from the video decoder 15 and data output from the subpicture decoder 13 in accordance with an instruction from the system controller 22, a video encoder 18 for converting synthesized data output from the video processor 17 into a video signal for display to display an image on an display device 20, and a D/A converter 16 for converting data output from the audio decoder 11 into an analog audio signal to provide to, for example a speaker 19.

The optical disk reproducing apparatus additionally comprises an operation section 21 having various operation keys such as a reproduction key and a stop key for instructing the system controller 22, respectively, to start and stop reproduction, and the system controller 22 for controlling the whole apparatus. It is noted that the operation section 21 may be a remote controller or an operation section provided on the operation panel of the apparatus main body.

The optical disk reproducing apparatus furthermore comprises a flash ROM 23 in which programs and data for controlling each component of the apparatus and the whole apparatus are stored, a CPU 24 for performing arithmetic processing in accordance with the programs and data in the flash ROM 23 to control the system controller 22, and a RAM 25 for storing data temporarily.

The system controller 22 includes, as components characterized by the present embodiment, a resume reproduction availability determining means 221 for obtaining and analyzing navigation pack information contained in disk information before starting the reproduction of main part information for the optical disk 1, and for determining whether or not the optical disk 1 can support resume reproduction, a resume reproduction availability information storage processing means 222 for storing, in the case the resume reproduction is determined to be available, resume reproduction availability information indicating the availability of the resume reproduction in the RAM 25, and a menu screen display processing means 223 for displaying a menu screen on the display device 20 when a menu key is pressed during the reproduction of the main part.

The system controller 22 also includes a resume information existence determining means 224 for determining whether or not there exists resume information stored in the RAM 25 when the menu key is pressed, and a message display processing means 225 for displaying a message indicating that pressing the menu key allows resume reproduction on the display device 20 in the case resume reproduction availability information is stored in the RAM 25 and the optical disk 1 can support resume reproduction, and when it is determined that there exists resume information by the resume information existence determining means 224.

The system controller 22 further includes a resume reproduction unavailability processing means 226 for indicating that the optical disk 1 cannot support resume reproduction and performing predetermined processing in the case no resume reproduction availability information is stored in the RAM 25 and the optical disk 1 cannot support resume reproduction, and when it is determined that there exists no resume information by the resume information existence determining means 224, and a resume reproduction means 227 for performing resume reproduction when the menu key is pressed after the message is displayed on the display device 20 by the message display processing means 225.

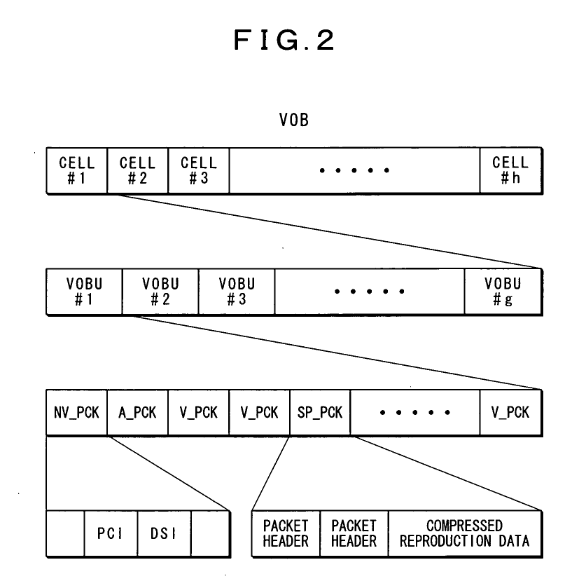

FIG. 2 is a view showing the data structure of a VOB (Video Object) containing video data, i.e., reproduction data used for reproducing a menu screen for selecting a title in the present embodiment.

In FIG. 2, the VOB consists of multiple cells, and each cell consists of multiple VOBU (Video Object Unit). Each VOBU (Video Object Unit) includes an NV_PCK (Navigation Pack) and at least one of V_PCK (Video Pack), SP_PCK (Subpicture Pack) and/or A_PCK (Audio Pack).

The NV_PCK (Navigation Pack) information contains RCI (Reproduction Control Information) and DSI (Data Search Information). In the RCI (Reproduction Control Information) and the DSI (Data Search Information) is set information such as the amount of data of the VOBU (Video Object Unit), the reproduction time between the start of the reproduction of a title and the start of the reproduction of the corresponding VOBU (Video Object Unit), and the position of a VOBU (Video Object Unit) to be reproduced subsequently. It is noted that in the case the optical disk can support resume reproduction, resume reproduction availability information for determining the availability of the resume reproduction is also contained in the RCI (Reproduction Control Information).

Each of V_PCK (Video Pack), SP_PCK (Subpicture Pack) and A_PCK (Audio Pack) includes a pack header containing information such as the type of reproduction data (video, subpicture, or audio), a packet header, and compressed reproduction data (video data, subpicture data, or audio data).

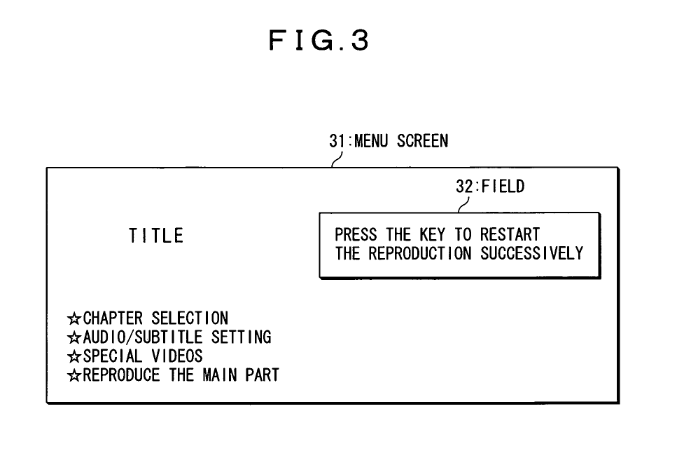

FIG. 3 is a view showing an example of the menu screen in the present embodiment. In FIG. 3, the numeral 31 indicates a menu screen of a title displayed on the display device 20 (refer to FIG. 1), while 32 indicates a field in which a message “Press the menu key to restart the reproduction successively” is displayed. Also, in the menu screen 31 are displayed items such as “Chapter selection” for selecting a chapter, “Audio/Subtitle setting” for setting a voice and/or subtitle, “Special videos” for reproducing making videos, etc., and “Reproduce the main part” for reproducing the main part. These display examples are merely ones, and not restricted thereto.

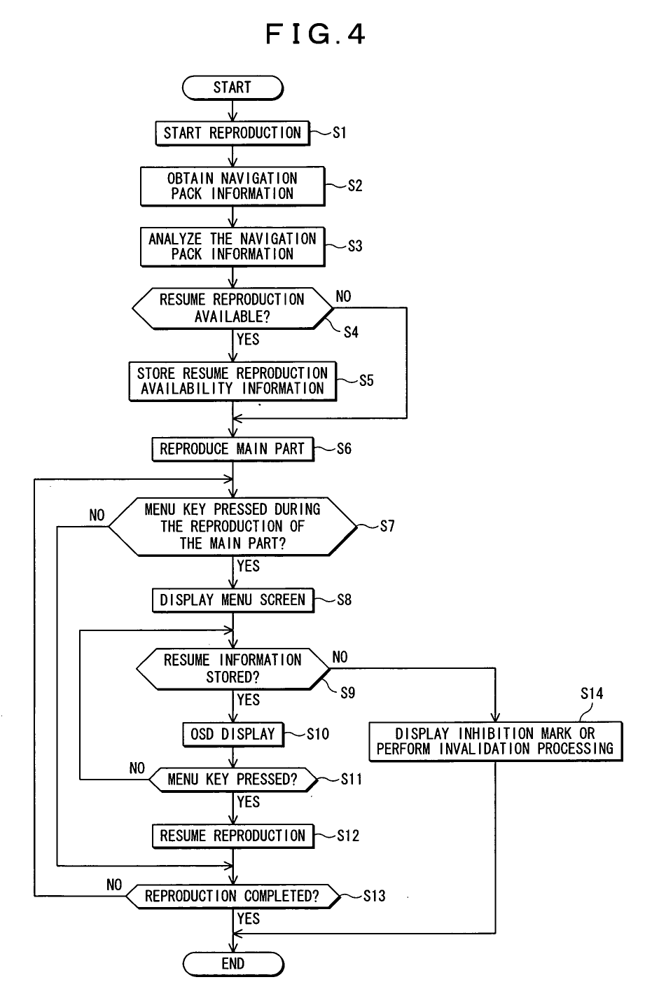

FIG. 4 is a flow chart illustrating processing associated with menu key operation in the present embodiment. The processing associated with menu key operation will be described with reference to the flow chart.

When the optical disk 1 is inserted into the optical disk reproducing apparatus and then the reproduction key in the operation section 21 is pressed to start the reproduction (step S1), navigation pack information described in FIG. 2 is obtained (step S2) and analyzed (step 3), and it is determined whether or not the optical disk 1 can support resume reproduction by the resume reproduction availability determining means 221 (step S4). In the case the resume reproduction is determined to be available, resume reproduction availability information indicating the availability of the resume reproduction is stored in the RAM 25 by the resume reproduction availability information storage processing means 222 (step S5).

Then, when a main part is reproduced (step S6) and the menu key in the operation section 21 is pressed during the reproduction of the main part (step S7), the reproduction is stopped and resume information at the point is stored in the RAM 25, and the menu screen is displayed on the display device 20 by the menu screen display processing means 223 (step S8).

Next, it is determined whether or not there exists resume information stored in the RAM 25 when the menu key is pressed by the resume information existence determining means 224 (step S9). In the case resume reproduction availability information is stored in the RAM 25 and the optical disk 1 can support resume reproduction, and when it is determined that there exists resume information by the resume information existence determining means 224, a message such as “Press the menu key to restart the reproduction successively” as shown in the field 32 on the menu screen 31 in FIG. 4 is OSD-displayed by the message display processing means 225 (step S10).

Then, when the menu key is pressed by a user in accordance with the message (step S11), so-called resume reproduction, which restarts the reproduction successively from the stop position when the menu key is pressed previously, is performed by the resume reproduction means 227 (step S12). With the completion of the reproduction (step S13), this processing is terminated. It is noted that when the menu key is pressed again during the resume reproduction, the pressing of the menu key is detected by the processing in step S7 and the same processing will be performed hereinafter.

In the case no resume reproduction availability information is stored in the RAM 25 and the optical disk 1 cannot support resume reproduction, and when it is determined that there exists no resume information by the resume information existence determining means 224 (step S9), it is indicated that the optical disk 1 cannot support resume reproduction and predetermined processing is performed by the resume reproduction unavailability processing means 226. If the optical disk 1 cannot support resume reproduction, an inhibition mark indicating the unavailability of resume reproduction is displayed on the menu screen or invalidation processing for processing associated with resume is performed for example (step S14).

As described heretofore, in accordance with the present embodiment, when the menu key is pressed, the message indicating that pressing the menu key again allows resume reproduction is displayed on the menu screen, which allows users to know that pressing the menu key again allows resume reproduction when requesting to restart the reproduction successively and thereby prevents users to perform an extraneous erroneous operation and facilitates a return when the menu key has been pressed erroneously during, for example, the reproduction of a main part, and further if the optical disk cannot support resume reproduction, displaying, for example, an inhibition mark indicating the unavailability of resume reproduction on the menu screen allows users to know that the optical disk cannot support resume reproduction. Therefore, the optical disk reproducing apparatus with this arrangement is easily operable for users and the operationality thereof is improved.

1. An optical disk reproducing apparatus for reproducing information recorded on optical disk, the apparatus comprising a system controller including:
a resume reproduction availability determining means for obtaining and analyzing navigation pack information contained in disk information before starting the reproduction of main part information for an optical disk, and for determining whether or not said optical disk can support resume reproduction;
a resume reproduction availability information storage processing means for storing, in the case said resume reproduction is determined to be available, resume reproduction availability information indicating the availability of said resume reproduction in a memory means;
a menu screen display processing means for displaying a menu screen on a display means when a menu key is pressed during the reproduction of said main part;
a resume information existence determining means for determining whether or not there exists resume information stored in said memory means when said menu key is pressed;
a message display processing means for displaying a message indicating that pressing said menu key allows resume reproduction on said menu screen in the case resume reproduction availability information is stored in said memory means and said optical disk can support resume reproduction, and when it is determined that there exists resume information by said resume information existence determining means;
a resume reproduction unavailability processing means for indicating that said optical disk cannot support resume reproduction and performing predetermined processing in the case no resume reproduction availability information is stored in said memory means and said optical disk cannot support resume reproduction, and when it is determined that there exists no resume information by said resume information existence determining means; and
a resume reproduction means for performing resume reproduction when said menu key is pressed after said message is displayed on said menu screen by said message display processing means.

2. An optical disk reproducing apparatus for reproducing information recorded on optical disk, the apparatus comprising a system controller adapted to control in such a manner that when a menu key is pressed during the reproduction of a main part in an optical disk capable of supporting resume reproduction, a message indicating that pressing said menu key allows resume reproduction is displayed on a menu screen.

3. The optical disk reproducing apparatus according to claim 2, wherein the determination whether or not said optical disk can support resume reproduction is made based on navigation pack information contained in disk information.

4. The optical disk reproducing apparatus according to claim 2, wherein said system controller comprises:
a resume reproduction availability determining means for obtaining and analyzing navigation pack information contained in disk information before starting the reproduction of main part information for said optical disk, and for determining whether or not said optical disk can support resume reproduction;
a resume reproduction availability information storage processing means for storing, in the case said resume reproduction is determined to be available, resume reproduction availability information indicating the availability of said resume reproduction in a memory means;
a menu screen display processing means for displaying said menu screen on a display means when said menu key is pressed during the reproduction of said main part;
a resume information existence determining means for determining whether or not there exists resume information stored in said memory means when said menu key is pressed;
a message display processing means for displaying a message indicating that pressing said menu key allows resume reproduction on said menu screen in the case resume reproduction availability information is stored in said memory means and said optical disk can support resume reproduction, and when it is determined that there exists resume information by said resume information existence determining means; and
a resume reproduction means for performing resume reproduction when said menu key is pressed after said message is displayed on said menu screen by said message display processing means.

5. The optical disk reproducing apparatus according to claim 4, wherein said system controller comprises a resume reproduction unavailability processing means for indicating that said optical disk cannot support resume reproduction and performing predetermined processing in the case no resume reproduction availability information is stored in said memory means and said optical disk cannot support resume reproduction, and when it is determined that there exists no resume information by said resume information existence determining means.
